(19) United States
(12) Patent Application Publication
(10) Pub. No.: US 2025/0156900 A1
(43) Pub. Date: May 15, 2025

(54) System And Method For The Quantitative Measurement and Reduction Of Marketing Entropy Using Geometric Methods And Heuristics

(71) Applicant: Pelatro Pte. Ltd., Singapore (SG)

(72) Inventors: Arun Kumar Krishna, Banaswadi (IN); Pramod Konandur Prabhakar, Banaswadi (IN)

(21) Appl. No.: 18/941,335

(22) Filed: Nov. 8, 2024

Related U.S. Application Data
(60) Provisional application No. 63/597,730, filed on Nov. 10, 2023.

(51) Int. Cl. G06Q 30/0242; G06Q 30/0204; G06Q 30/0251

(52) U.S. Cl. CPC G06Q 30/0246; G06Q 30/0204; G06Q 30/0269

(57) ABSTRACT

Quantitative techniques to measure and reduce the entropy in customer centric marketing activities in large enterprises using geometric methods and heuristics. Quantitative real time representations of marketing efforts, their effects and relative returns as line segments of a triangle with their lengths denoting the digitally encoded weights of the relations of the corresponding constituents pairwise. Hierarchically entropy deduction using mathematical formulae to deduce entropy from a nine-point circle formed of the triangle constructed to empirically assess marketing activities to customer journeys. Identification means to determine effectiveness and sensitivity to such marketing efforts by particularized customer types and clusters with automated recommendations in the form of prescription of lower activity levels of a segment or total suspension of marketing activity levels to reduce the overall entropy in marketing activity.

### CROSS REFERENCE TO RELATED APPLICATIONS

To the full extent permitted by law, the present United States Non-Provisional patent application hereby claims priority to and the full benefit of, U.S. Provisional Application No. 63/597,730, filed Nov. 10, 2023, entitled “Quantitative techniques to measure and reduce the entropy in customer centric marketing activities in large enterprises using geometric methods and heuristics (Mottainai)”, which is incorporated herein by reference in its entirety.

### FIELD OF THE DISCLOSURE

The present disclosure is directed to organization of user-relevant data in connection with user's interactions with the organization and leveraging real-time data to influence user behavior. More specifically, the present disclosure provides a geometric framework to model unproductive marketing activities as entropy for the analyzation and reduction thereof.

The present disclosure is not limited to any specific file management system, user or customer type, database structure, physical computing infrastructure, enterprise resource planning (ERP) system/software/service, computer code language, or services offering.

### BACKGROUND OF THE DISCLOSURE

Telecommunications companies, software service providers, financial institutions, social media services, and other user-service based businesses may generally have a large volume of customers, users, clients, and/or subscribers. Those businesses having such large customer volumes may generally further experience voluminous interactions with those customers, which may be enormous in scale and on a continuous basis. Data related to these volumes of interactions are generally highly valuable intellectual property to the businesses, which may be highly relevant to the core products and services of the business, but technical challenges exist as it may relate to meaningful use of the data, either with regard to real-time user behavior or to historical behaviors, patterns, and activities. Marketing is essential for businesses to reach and engage customers, but it can often be wasteful, ineffective, and even counterproductive. Companies dedicate significant resources to marketing, aiming to increase brand awareness, drive sales, and foster customer loyalty. However, traditional marketing techniques often lead to excessive expenditure and an overwhelming volume of marketing noise, which can alienate consumers rather than attract them.

Recognizing the value of a business's data and the importance of marketing to further driving the overall business's value, many organizations may study, analyze, interpret and act on customer interaction data to drive marketing. However, marketing itself has associated costs. Marketing involves numerous costs that can quickly accumulate, including expenses for designing and producing advertisements, purchasing media space across various platforms (such as television, radio, online, and print), and leveraging data analytics tools to segment and understand target audiences. Additionally, companies often spend on hiring specialized marketing agencies, purchasing ad tech software, and investing in social media campaigns. There are also costs associated with content creation, including video production, copywriting, graphic design, and photography, as well as maintaining an active online presence through paid search, influencer partnerships, and sponsored posts. Further expenses can include customer surveys, brand tracking studies, and other research activities to assess campaign impact, which, while necessary, add to the overall cost of marketing initiatives.

Evaluating marketing effectiveness (i.e., cost effectiveness) is complex involving several methods, each with its own benefits and challenges. One approach is to analyze sales and revenue metrics before, during, and after campaigns to see if there is a correlation with marketing efforts. However, external factors (e.g., seasonal changes, competitor actions, conflicting/consistent campaign(s), or economic shifts) can influence these metrics, making it difficult to isolate any specific marketing campaign's discrete impact. Another common method, which is especially relevant to large-data large-customer based businesses, is tracking consumer engagement metrics (e.g., clicks, likes, shares, and conversions) to assess interest and responsiveness. Other methods may prove more investigative, but also more costly. Accordingly, surveys and customer feedback can offer insights into customer perceptions and awareness, helping assess whether marketing messages are resonating. A/B testing allows for comparing variations of a campaign to see which performs better. Finally, by way of example and not limitation, companies may use attribution modeling, a data-driven technique that tracks customer interactions across touchpoints to determine which activities contribute most to conversions. Attribution models, however, are often difficult to implement accurately due to privacy regulations, incomplete data, and challenges in integrating information across channels. Additionally, without a comprehensible heuristic framework to map various consumer data (historic and/or real time) to the marketing activities themselves (whether historic or in real time), comparison among campaigns, user segments, and revenue generated can become unwieldy, and can fail to be useful to an organization seeking to optimize its marketing potential.

An ideal in customer-centric marketing is to prioritize personalization down to the “segment of one”, or tailoring engagements uniquely to each individual customer. In other words, modelling customer interactions of smaller, friendlier, more service-oriented, and more personal businesses. For large organizations with customer bases spanning hundreds of millions of subscribers, achieving this degree of personalization might be impossible and only an ideal, but given sufficient real-time data, in theory, an approximation could be made through an intricate understanding of marketing efforts and their diverse effects over time. Mapping and analyzing this expansive “universe” of marketing activities, which can comprise countless interactions, channels, and tactics, is both complex and resource-intensive. Traditional marketing analytics approaches often struggle to capture the nuanced, individual-level dynamics within such vast datasets, especially when seeking to understand engagement patterns, anticipate customer responses, and optimize efforts for maximum impact. As a result, these analyses frequently fall short of accurately representing the real-world constructs that drive customer behavior and may lead to various inefficiencies in marketing strategies.

To address this, there is a need for a comprehensive model that can geometrically represent the universe of marketing activities in a way that aligns with these customer-centric goals. Such a model may systematically quantify engagement entropy, which may be understood as the disorder and randomness of individual interactions within a structured mathematical formulation. This formulation may then leverage the area within those bounds and in its surroundings to represent engagement dynamics, enabling a deeper understanding of individual and aggregate behaviors.

Through an entropy-based approach, on that seeks to understand and limit its effect on the organization, engagement can then be quantified at the individual level while still extrapolating these findings across the entire marketing universe, identifying clusters of customers with similar engagement patterns and effort-effect dynamics. These clusters may then in turn allow enterprises to make informed adjustments to marketing activities that aim to reduce system-wide entropy. By doing so, companies can streamline marketing efforts, enhance personalization effectiveness, and reduce wasteful marketing, aligning more closely with customer-centricity goals.

Therefore, a need persists for system and method for the quantitative measurement and reduction of marketing entropy using geometric methods and heuristics. This disclosure addresses these challenges by providing a unified approach that encompasses all these aspects, offering a superior solution compared to prior attempts. The disclosed system and method may accomplish this by offering a unique combination of features, including a geometric model for mapping marketing efforts, effects, and returns in real time and simulating, investigating, and otherwise analyzing marketing efforts on a customer population.

### SUMMARY OF THE DISCLOSURE

The present disclosure may solve the aforementioned limitations of the currently available systems and methods of measuring marketing entropy by providing a system and method for the quantitative measurement and reduction of marketing entropy using geometric methods and heuristics. These systems and methods may accomplish such by providing a comprehensive and quantifiable approach to measure and model marketing efforts, their effects, and the relative returns they generate which has been lacking. The present disclosure addresses this challenge by introducing a triangle model t that represents marketing activities at the individual level. This model may feature three vertices: Efforts (F), Effects (E), and Relative Returns (R). The sides of the triangle-Efforts-Effects (FE), Effects-Relative Returns (ER), and Relative Returns-Efforts (RF)-represent the pairwise relationships between these key marketing constituents.

With respect to the effects vertex, it may be modeled as a function of various outcomes, both monetary and non-monetary, which encompass metrics such as Return on Investment (ROI), Assets Under Management (AUM), profitability, Customer Satisfaction (CSAT), and other factors that collectively contribute to net gains or losses. This comprehensive approach allows businesses to consider both customer-centric and profit-centric objectives in assessing the impact of their marketing strategies.

With respect to the system's modelling of marketing efforts—communications, nudges, and other engagements—it may do so along a linear axis. This method may segment marketing efforts into gradients of non-uniform lengths and apply a function to assign the length for the FE segment of the triangle in relation to an individual subscriber. Additional functions are provided to determine the lengths of ER and RF segments, offering a complete representation of the triangle TT for each subscriber.

In a related aspect, a computer-assisted technique may deduce the nine-point center (NPO) of a nine-point circle (NPC), which may represent entropy (E) at the subscriber level. This entropy may be derived using algebraic functions based on geometric measurements such as the area, perimeter, and lengths of sub-arcs and chords within the nine-point circle as it relates to triangle model t and its various altitudes, intersections and midpoints thereof. This technique may enable a unique quantitative assessment of marketing activity entropy at the subscriber level. By modelling efforts, their effects, and relative returns to obtain entropy in this manner, a hierarchical method for aggregating entropy measures from individual subscribers to larger clusters can be enabled, ultimately enabling the computation of entropy at the organizational level. This aggregation supports the analysis of marketing efficiency across different segments and aids in identifying entropy-related patterns and across various campaigns, some of which may conflict. Additionally, by obtaining marketing entropy values across customer populations, methods for discovering “isothermal zones”, or collections of triangles with similar entropy values, in order to indicate behavioral clusters of subscribers, which can be targeted for further marketing and/or study. These clusters may then represent and/or reveal subscribers who share similar experiences and reactions to marketing activities, providing valuable insights into customer behavior and engagement. Additional exemplary features of the system and method for the quantitative measurement and reduction of marketing entropy using geometric methods and heuristics may include other various geometric, algebraic, and mathematical concepts to model marketing events and their effects over time.

The systems and methods of the disclosure may accomplish the above through a plurality of numerical, statistical, graphical, geometric and heuristics-based techniques applied to incoming user interaction data in relation to historic and predictive data, each of which are covered in detail below in relation to the Drawings. In summary, such techniques may begin with and/or rely on streaming ingestion of digital interactions of customers across channels, the accumulation of such data, the monitoring of patterns/associations of such data to predictive models as well as to customer stimuli, and recommended actions and/or prescriptive strategies to decrease marketing entropy, increasing metrics toward business objectives and the monitoring of performance thereof.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed

Description with reference to the accompanying drawings, which are not necessarily drawn to scale, and in which like reference numerals denote similar structure and refer to like elements throughout, and in which:

FIG. 1A is a block diagram of a computer system of the present disclosure;

FIG. 1B is a block diagram of a communications system implemented by the computer system in FIG. 1;

FIGS. 2a-b are block diagrams of exemplary B2C communication/interaction systems of the disclosure;

FIGS. 3A-C are illustrations of geometric principles as they relate to mapping marketing entropy;

FIG. 4 is a line illustration of exemplary organization schema of the disclosure;

FIG. 5 is a flowchart diagram of initial organizational steps of the methods of the disclosure;

FIG. 6 is a flowchart diagram of additional organizational steps of the disclosure;

FIG. 7 is a block diagram of an exemplary heuristic;

FIG. 8 shows block diagrams representing various exemplary customer journey types;

FIG. 9 is a method flowchart of an exemplary entropy recalibration and reduction process; and

FIG. 10 is a proposed prescriptive Boolean table of impact overlay curves and exemplary curves thereof.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

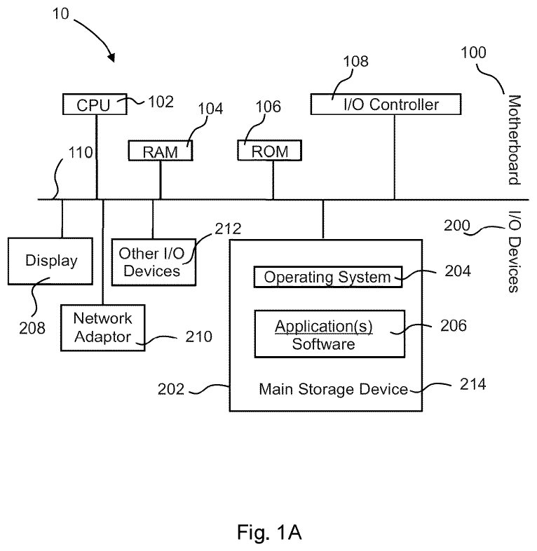

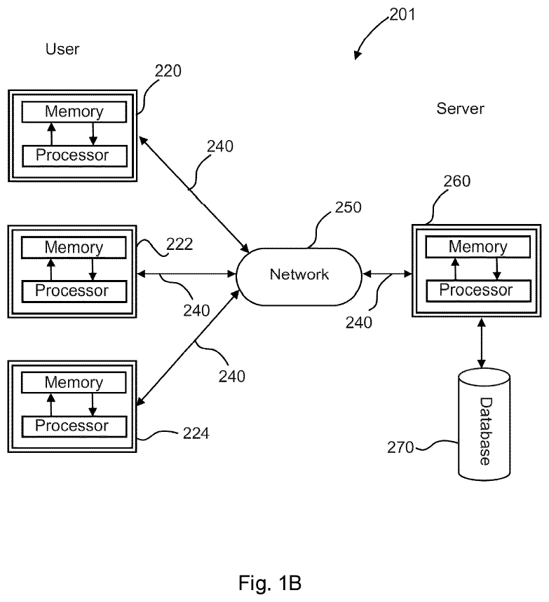

Referring now to FIGS. 1-10, in describing the exemplary embodiments of the present disclosure, specific terminology is employed for the sake of clarity. Certain terms, as they may be relevant to the quantitative assessment of user and subscriber behaviors as well as business actions to elicit certain behaviors may be defined as follows. An interaction may mean any distinct/discrete touchpoint between a user/subscriber and a business at a specific time, though potentially with a plurality of purposes to achieve a business objective. Such interaction could come in many varieties, including an informational message, a phone call, a coupon, an offer for a new service addition, the like and/or combinations thereof. Engagement may mean a group of interactions having some cohesivity toward a business objective. A micro-journey may mean any activity experienced and/or performed by a user/subscriber which has a purpose in the mind of the user/subscriber. A journey may mean the interactions, engagements, micro-journeys, and other events between the user and business as may be observed by the business toward one or more business objectives. The present disclosure may use the terms customer, user, subscriber, consumer, and advocate interchangeably, and the disclosure is not so limited to those which an individual pays or otherwise financially rewards a business for provision of products and/or services, which may also be used interchangeably herein. Additionally, as may be important to the mathematical and trigonometric features of the disclosure, certain conventions for the naming of triangles may be observed and/or not included for purposes such as emphasis upon a specific angle, side, or other feature of such triangles. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

The present disclosure solves the aforementioned limitations of the currently available devices, computerized systems, and methods thereof for collecting, organizing, and curating customer engagements across multiple domains to provide contextual nurturing and alignment of customer journeys to business objectives.

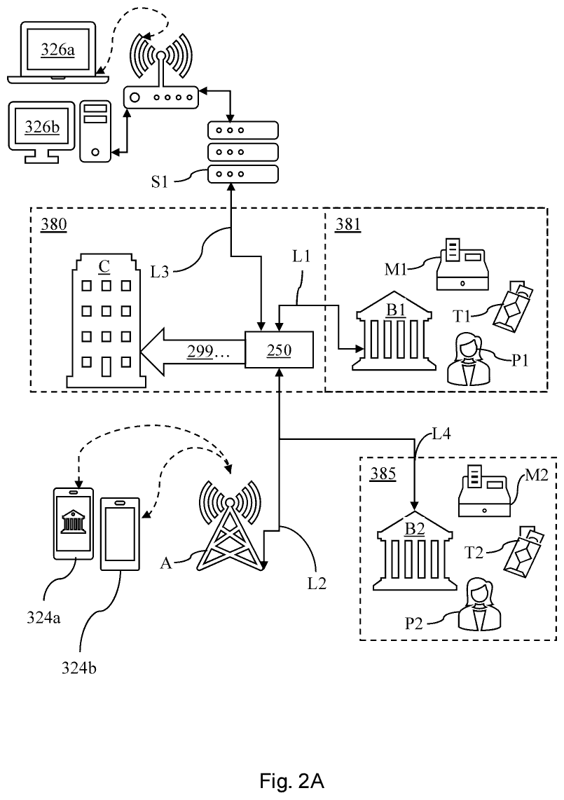

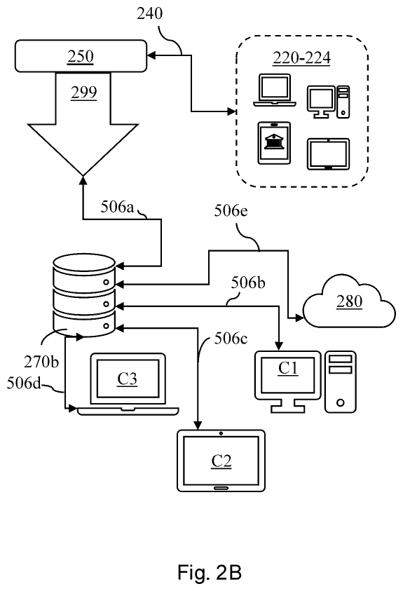

In describing the exemplary embodiments of the present disclosure, as illustrated in FIGS. 1A-1B. specific terminology is employed for the sake of clarity. The present disclosure, however, is not intended to be limited to the specific terminology so selected, and it is to be understood that each specific element includes all technical equivalents that operate in a similar manner to accomplish similar functions. The claimed invention may, however, be embodied in many different forms and should not be construed to be limited to the embodiments set forth herein. The examples set forth herein are non-limiting examples, and are merely examples among other possible examples. It should further be noted that with respect to FIGS. 1A-1B, FIGS. 2A-2B, as well as other Drawings of the disclosure, vast simplification of these techniques may be described herein in order to succinctly demonstrate various features of the disclosure, but applicability to larger, vastly more complicated systems may be achieved by those having ordinary skill in the art using other steps, features, systems, methods, and techniques as may be disclosed herein.

As will be appreciated by one of skill in the art, the present disclosure may be embodied as a method, data processing system(s), software as a service (SaaS), computer program product(s), artificial intelligence system(s), large language model(s), the like and/or combinations thereof. Accordingly, the present disclosure may take the form of an entirely hardware embodiment, an entirely software embodiment or an embodiment combining software and hardware aspects in order to solve the various technical problems with the various technical solutions as may be disclosed herein. Furthermore, the present disclosure may take the form of a computer program product on a computer-readable storage medium having computer-readable program code means embodied in the medium. Any suitable computer readable medium may be utilized, including hard disks, ROM, RAM, CD-ROMs, electrical, optical, magnetic storage devices and the like.

The present disclosure is described below with reference to block and flowchart illustrations of methods, apparatus (systems) and computer program products according to embodiments of the present disclosure. It will be understood that each block or step of the flowchart illustrations, and combinations of blocks or steps in the flowchart illustrations, can be implemented by computer program instructions or operations. These exemplary computer program instructions, functions, equations, and/or operations may be loaded onto a general-purpose computer, special purpose computer, server, or other programmable data processing apparatus to produce a machine, such that the instructions or operations, which execute on the computer or other programmable data processing apparatus, create means for implementing the functions specified in the flowchart block or blocks/step or steps.

These computer program instructions or operations may also be stored in a computer-usable memory that can direct a computer or other programmable data processing apparatus to function in a particular manner, such that the instructions or operations stored in the computer-usable memory produce an article of manufacture including instruction means which implement the function specified in the flowchart block or blocks/step or steps. The computer program instructions or operations may also be loaded onto a computer or other programmable data processing apparatus (processor) to cause a series of operational steps to be performed on the computer or other programmable apparatus (processor) to produce a computer implemented process such that the instructions or operations which execute on the computer or other programmable apparatus (processor) provide steps for implementing the functions specified in the flowchart block or blocks/step or steps. Accordingly, blocks or steps of the flowchart illustrations support combinations of means for performing the specified functions, combinations of steps for performing the specified functions, and program instruction means for performing the specified functions. It should also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions or operations.

Computer programming for implementing the present disclosure may be written in various programming languages, database languages, the like and/or combinations thereof. However, it is understood that other source or object-oriented programming languages, and other conventional programming language may be utilized without departing from the spirit and intent of the present disclosure.

Referring now to FIG. 1A specifically, there is illustrated a block diagram of a simplified computing system 10 that provides a suitable environment for implementing embodiments of the present disclosure. The computer architecture shown in FIG. 1A, as may be well understood by those having ordinary skill in the art, is divided into two parts—motherboard 100 and the input/output (I/O) devices 200. Motherboard 100 preferably includes subsystems and/or processor(s) to execute instructions such as central processing unit (CPU) 102, a memory device, such as random-access memory (RAM) 104, input/output (I/O) controller 108, and a memory device such as read-only memory (ROM) 106, also known as firmware, which are interconnected by bus 110. A basic input output system (BIOS) containing the basic routines that help to transfer information between elements within the subsystems of the computer is preferably stored in ROM 106, or operably disposed in RAM 104. Computing system 10 further preferably includes I/O devices 202, such as main storage device 214 for storing operating system 294 and instructions or application program(s) 206, and display 208 for visual output, and other I/O devices 212 as appropriate. Main storage device 214 preferably is connected to CPU 102 through a main storage controller (represented as 108) connected to bus 110. Network adapter 210 allows the computer system to send and receive data through communication devices or any other network adapter capable of transmitting and receiving data over a communications link that is either a wired, optical, or wireless data pathway. It is recognized herein that central processing unit (CPU) 102 performs instructions, operations or commands stored in ROM 106 or RAM 104.

Processor 102 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1A as a single processor, in some embodiments, processor 102 comprises a plurality of processors. The plurality of processors may be embodied on a single computing device or may be distributed across a plurality of computing devices collectively configured to function as the computing device 10. The plurality of processors may be in operative communication with each other and may be collectively configured to perform one or more functionalities of the computing device 10 as described herein. In an example embodiment, processor 102 is configured to execute instructions stored in memory 104, 106 or otherwise accessible to processor 102. These instructions, when executed by processor 102, may cause the computing device 10 to perform one or more of the functionalities of the computing device 10 as described herein.

Whether configured by hardware, firmware/software methods, or by a combination thereof, processor 102 may comprise an entity capable of performing operations according to embodiments of the present invention while configured accordingly. Thus, for example, when processor 102 is embodied as an ASIC, FPGA or the like, processor 102 may comprise specifically configured hardware for conducting one or more operations described herein. As another example, when processor 102 is embodied as an executor of instructions, such as may be stored in memory 104, 106, the instructions may specifically configure processor 102 to perform one or more algorithms and operations described herein.

The plurality of memory components 104, 106 may be embodied on a single computing device 10 or distributed across a plurality of computing devices. In various embodiments, memory may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 104, 106 may be configured to store information, data, applications, instructions, or the like for enabling the computing device 10 to carry out various functions in accordance with example embodiments discussed herein. For example, in at least some embodiments, memory 104, 106 is configured to buffer input data for processing by processor 102. Additionally or alternatively, in at least some embodiments, memory 104, 106 may be configured to store program instructions for execution by processor 102. Memory 104, 106 may store information in the form of static and/or dynamic information. This stored information may be stored and/or used by the computing device 10 during the course of performing its functionalities.

Many other devices or subsystems or other I/O devices 212 may be connected in a similar manner, including but not limited to, devices such as microphone, speakers, flash drive, CD-ROM player, DVD player, printer, main storage device 214, such as hard drive, and/or modem each connected via an I/O adapter. Also, although preferred, it is not necessary for all of the devices shown in FIG. 1A to be present to practice the present disclosure, as discussed below. Furthermore, the devices and subsystems may be interconnected in different configurations from that shown in FIG. 1A, or may be based on optical or gate arrays, or some combination of these elements that are capable of responding to and executing instructions or operations. The operation of a computer system such as that shown in FIG. 1A is readily known in the art and is not discussed in further detail in this application, so as not to overcomplicate the present disclosure with unnecessary recitations of well-known computing technologies.

In some embodiments, some or all of the functionality or steps may be performed by processor 102. In this regard, the example processes and algorithms discussed herein can be performed by at least one processor 102. For example, non-transitory computer readable storage media can be configured to store firmware, one or more application programs, and/or other software, which include instructions and other computer-readable program code portions that can be executed to control processors of the components of system 201 to implement various operations, including the examples shown above. As such, a series of computer-readable program code portions may be embodied in one or more computer program products and can be used, with a computing device, server, and/or other programmable apparatus, to produce the machine-implemented processes discussed herein.

Any such computer program instructions and/or other type of code may be loaded onto a computer, processor or other programmable apparatuses circuitry to produce a machine, such that the computer, processor or other programmable circuitry that executes the code may be the means for implementing various functions, including those described herein.

Referring now to FIG. 1B, there is illustrated a diagram depicting an exemplary system 201 in which concepts consistent with the present disclosure may be implemented or performed. Those having ordinary skill in the art may recognize this, the previous, and remaining examples as heavily simplified for the purposes of illustration, especially in relation to the voluminous networked devices featured in examples of the disclosed system and method for the quantitative measurement and reduction of marketing entropy using geometric methods and heuristics. Examples of each element within the communication system 201 of FIG. 1B are broadly described above with respect to FIG. 1A. In particular, the server system 260 and user system 220 have attributes similar to computer system 10 of FIG. 1A and illustrate one possible implementation of computer system 10. Communication system 201 preferably includes one or more user systems 220, 222, 224, one or more server system 260, and network 250, which could be, for example, the Internet, public network, private network or cloud. User systems 220-224 each preferably include a computer-readable medium, such as random-access memory, coupled to a processor. The processor, CPU 102, executes program instructions or operations stored in memory. Communication system 201 typically includes one or more user system 220. For example, user system 220 may include one or more general-purpose computers (e.g., personal computers), one or more special purpose computers (e.g., devices specifically programmed to communicate with each other and/or the server system 260), a workstation, a server, a device, a digital assistant or a “smart” cellular telephone or pager, a digital camera, a component, other equipment, or some combination of these elements that is capable of responding to and executing instructions or operations.

Similar to user system 220, server system 260 preferably includes a computer-readable medium, such as random-access memory, coupled to a processor. The processor executes program instructions stored in memory. Server system 260 may also include a number of additional external or internal devices, such as, without limitation, a mouse, a CD-ROM, a keyboard, a display, a storage device and other attributes similar to computer system 10 of FIG. 1A. Server system 260 may additionally include a secondary storage element, such as database 270 for storage of data and information. Server system 260, although depicted as a single computer system, may be implemented as a network of computer processors. Memory in server system 260 contains one or more executable steps, program(s), algorithm(s), or application(s) 206 (shown in FIG. 1A). For example, the server system 260 may include a web server, information server, application server, one or more general-purpose computers (e.g., personal computers), one or more special purpose computers (e.g., devices specifically programmed to communicate with each other), a workstation or other equipment, or some combination of these elements that is capable of responding to and executing instructions or operations.

System 201 is capable of delivering and exchanging data between user system 220 and a server system 260 through communications link 240 and/or network 250. Through user system 220, users can preferably communicate over network 250 with each other user system 220, 222, 224, and with other systems and devices, such as server system 260, to electronically transmit, store, manipulate, and/or otherwise use data exchanged between the user system and the server system. Communications link 240 typically includes network 250 making a direct or indirect communication between the user system 220 and the server system 260, irrespective of physical separation. Examples of a network 250 include the Internet, cloud, analog or digital wired and wireless networks, radio, television, cable, satellite, and/or any other delivery mechanism for carrying and/or transmitting data or other information, such as to electronically transmit, store, manipulate, and/or otherwise modify data exchanged between the user system and the server system. The communications link 240 may include, for example, a wired, wireless, cable, optical or satellite communication system or another pathway. It is contemplated herein that RAM 104, main storage device 214, and database 270 may be referred to herein as storage device(s) or memory device(s).

With respect to FIG. 2A, therein illustrated is a block chart of an exemplary intake ingestion scheme of the exemplary telecommunication network and computerized services infrastructure, which may access or be in receipt of certain financial, social media, entertainment, or other networks via datastream 299 as may be herein described and/or recognized by those having ordinary skill in the art, and may be described in a basic exemplary embodiment in FIG. 2A. Basic components, which may or may not be required depending on the users/systems/subscribers/customers/content being monitored, studied, or stored, are exemplary only. A system and method according to the disclosure may be and likely is more complicated than may be illustrated in FIGS. 1A, 1B, 2A, 2B and otherwise, and may involve multiple (or numerous) towers, user devices, networks, servers, users, the like, and/or combinations thereof as may be understood by those having ordinary skill in the art. Beginning with various subscriber/user interaction(s) with various telecommunications and other computerized services infrastructure, first subscriber device 324a and second subscriber device 324b may each interact with antenna A (via wired or wireless connections), which may in turn transmit data and/or communicate via telecommunication line L2 with, for example, corporate servers C via network 250, which may or may not form a part of, for instance, the Internet, and other devices on network 250, which may reside on corporate network infrastructure 380, which may include exemplary database 270b, user systems 220, 222, 224 and agent systems C1-C3 (see FIG. 2B) via e.g., network lines 240 (see FIG. 1B) or communication links L1-L4. As may be understood by those having ordinary skill in the art, certain subscriber devices, such as e.g., first subscriber device 324a, may feature a mobile application configured to perform certain functions within the services domain of the business and communicate therewith via a credentialling system, which may be secure. Additionally, other user devices, such as laptop 326a, desktop 326b, and external server S1 may communicate similarly to network 250 and so on. Importantly, various branches of a business may operate via public and/or private networks to network 250, such as branch office B1 and branch office B2, which may feature among connected branch devices 381 and connected branch devices 385, respectively, through use of POS systems M1-M2, automated customer machines T1-T2, and branch associate machines P1-P2. Obviously, a high volume system, such as those designed to benefit from the disclosed system and method for the quantitative measurement and reduction of marketing entropy using geometric methods and heuristics may be much more complicated than the elementary network examples provided herein, and may feature many hundreds or even millions of such exemplary devices as illustrated herein, and be connected via means known by those having ordinary skill in the art. By way of example and not limitation, such networks may take the form of private networks, virtual private networks, secure connections on the Internet or the Web, the like, and/or combinations thereof. These systems and the various communications and/or transactions thereof in communication with corporate servers C may obtain vast quantities of data via one or more of datastream 299, such that customer/user interactions may be received, stored, catalogued, analyzed, reported, and otherwise acted upon as may be herein described. The above communications and computerized services environment, at least with respect to the disclosed system and method for the quantitative measurement and reduction of marketing entropy using geometric methods and heuristics, its features and benefits, and potential implementations may be even better understood by those having skill in the art from a review of the remaining FIGS. 2B-11, in addition to the accompanying Detailed Description.

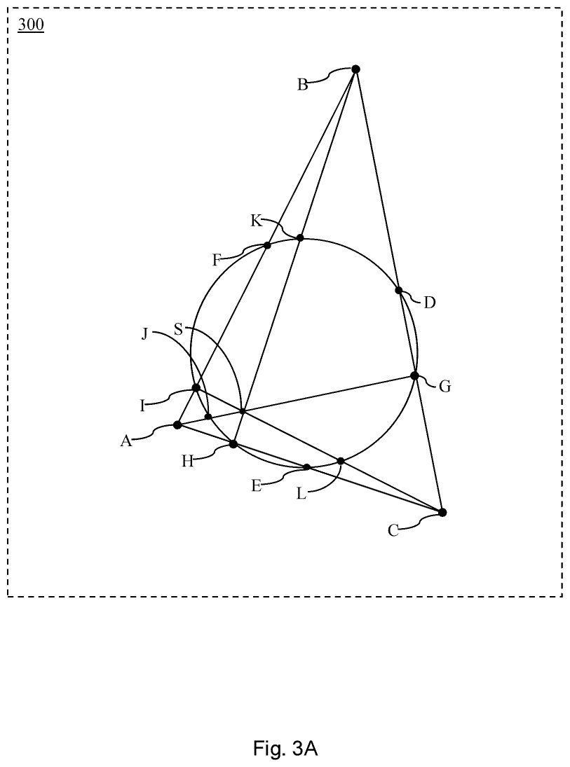

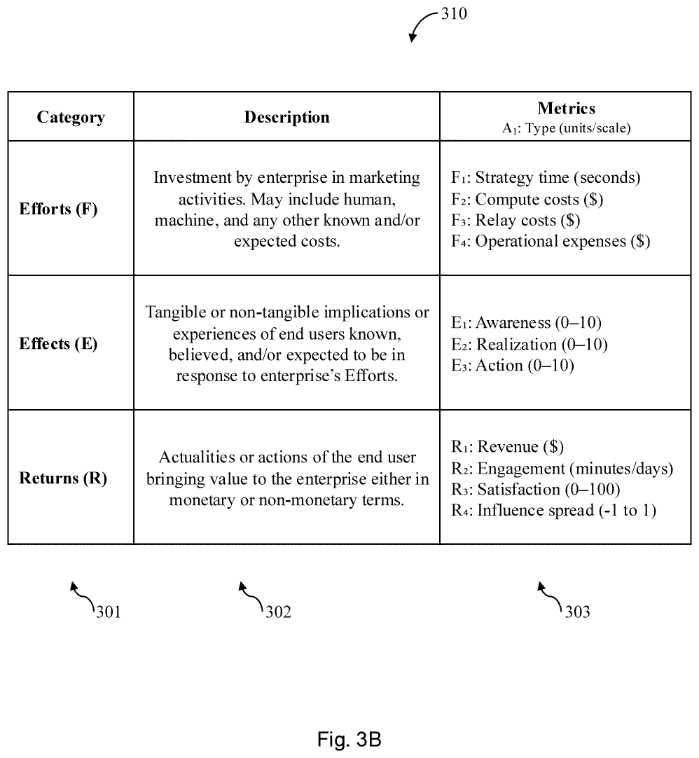

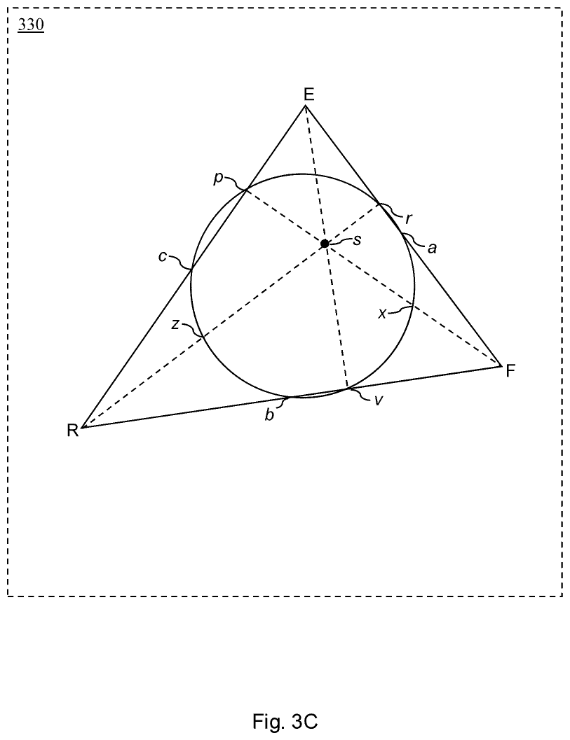

Referring now specifically to FIG. 2B, therein illustrated is a block diagram of exemplary business-to-consumer (B2C) communication/interaction system of the disclosure in receipt of datastream 299 via network 250 as described above. As may be understood by those having ordinary skill in the art, one or more exemplary database 270b may be the primary recipient of comprehensive data, from e.g., user systems or devices 220-240, much of which may be relevant to transactions, communications sent/received, information thereof, and other services performed by the company, which may be relevant to the overall performance and interests of the company as may be herein described. Such datastream 299 may be received via communications link 506a by exemplary database 270b, where it may be again transmitted via appropriate channels to accomplish such transactions and/or services. Exemplary database 270b may further feature comprehensive and/or sophisticated hardware and software installed thereon to perform the various tasks, analyses, data transformations, and computations as may be herein described and may in turn communicate the results thereof or receive instructions to perform such tasks to and/or from corporate systems C1-C3, and such communications may be accomplished via links 506b, 506c, and 506d, respectively. Additionally, certain other devices owned and/or authorized by the company to access, process, or otherwise perform tasks upon such data within datastream 299 may do so through private cloud 280, which may further be connected to exemplary database 270b, or alternatively through private and/or secure connections thereof via network 250. The above communications and computerized services environment as illustrated herein FIG. 2B, as well as those described above in relation to FIG. 2A, at least with respect to the disclosed system and method for collecting, organizing, and curating customer engagements across multiple domains to provide contextual nurturing and alignment of customer journeys to business objectives, its features and benefits, and potential implementations may be further understood by those having skill in the art from a review of the remaining FIGS. 3-10, in addition to the accompanying Detailed Description.

Turning to FIGS. 3A-C, generally they may be collectively understood as providing an exemplary general heuristics framework for the mapping of customer marketing entropy, which may be best understood as any marketing activity that was unproductive and/or counterproductive. Beginning with FIG. 3A, illustrated therein is nine-point circle diagram 300. In geometry, the nine-point circle is a circle that can be constructed for any given triangle. It is so named because it passes through nine significant concyclic points defined from the triangle. These nine points are: (D, E, F) the midpoint of each side of the triangle, (G, H, I) the foot of each altitude, and (J, K, L) the midpoint of the line segment from each vertex of the triangle to the orthocenter. Turning to FIG. 3B, Efforts F, Effects E, and Returns R can provide a formulation for providing concrete metrics for mapping various marketing activities and their effects. Table 310 contains exemplary description of such a formulation. So, for example, the costs associated with Efforts F could be categorized as f₁ as strategy time, f₂ as computing costs, f₃ as relay costs, and f₄ as operational expenses. These costs may be based on estimates or actual figures, and for example, feature spectrums. For example, if marketing domain experts are being considered for a particular strategy, $1,000 may be estimated for their hourly cost, analysts at $200/hr., and junior analysts at $100/hr., these costs may be factored variously into f₁ strategy time to further enhance the specific marketing recommendation(s). It may be critical to the understanding of those having ordinary skill in the art that strategy time cost specifically may not necessarily be true bills to the enterprise and may not necessarily add to actual marketing budget. These instead may be used in relative sense as successful strategy efforts can be used in future campaigns using that strategy. In other words, costs spent planning can be amortized on a per-subscriber and time perspective, whereas costs spent executing the plan (e.g., sending marketing offers) occur during that plan's execution. Considering an example where 8 hours were spent on expert strategy, 18 on analyst time, and 24 hours on junior analyst time, costing $11,600, the f₁ strategy time cost on a per-subscriber basis for “X” offers sent to “S” subscribers may be fairly obtained by the following formula:

$$\frac{{f}_{1}}{X} * {( \frac{X}{S} )}^{1.1} .$$

Then, considering an example where 10 M offers were used for 6 M subscribers,

$$\frac{\$11 , 600}{10 , 000 , 000} * {( \frac{10 , 000 , 000}{6 , 000 , 000} )}^{1.1} = \$0 \text{.00203464} .$$

Then, when it comes to calculating a f₂ computing costs, certain knowledge of the enterprise's cloud and/or network architecture may be necessary to valuably assess and estimate computing costs as it may relate to any various marketing campaign and the machines and computing/networking resources required to achieve it. Once the hours of usage by instance type is tabulated (or other recognized method of estimating computing costs has been performed), f₂ computing cost can be tabulated by instance type (I) using the following formula f₂=>Σᵢ₌₁^{i=h} Iᵢ*(hours of Iᵢ)*Iᵢcost. Then, in calculating the per-subscriber computing costs, it may be beneficial to discount computing costs to account for boot and shutdown costs not attributed to targeting activity using the formula:

$$\frac{{f}_{2}}{X} * \frac{X}{2} * 0.75 ,$$

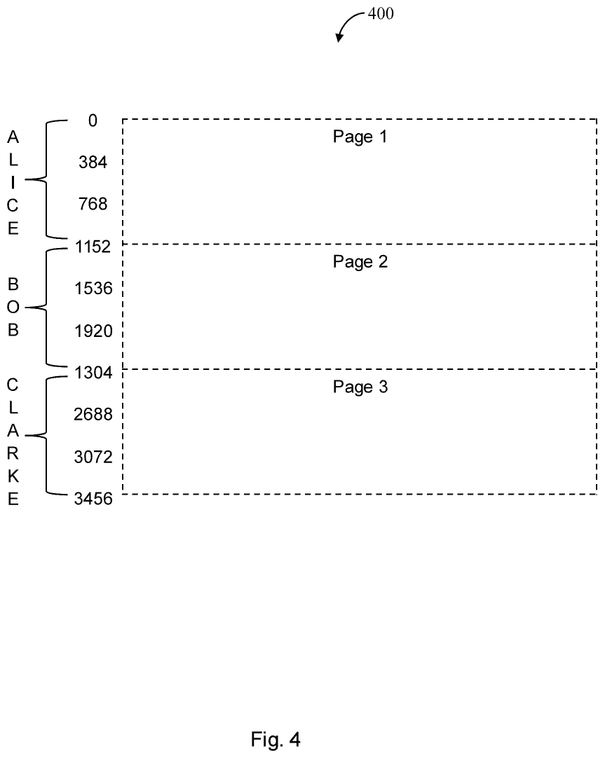

when a 25% discount is applied for boot/shutdown costs. Additionally, costs related to certain groups not being studied, modeled, or otherwise influenced by the system and method for the quantitative measurement and reduction of marketing entropy using geometric methods and heuristics (e.g., control groups, groups excluded from contacting), though still subject to the computing costs, may need to be included. Such costs may be accounted for in a number of ways, for example, through a simple multiplier. Other costs, such as f₃ relay costs, may be computed based on actual costs on an e.g., daily basis and uniformly distributed across all subscribers who offers were communicated proportionate to the offers sent/received. So, f₃ relay costs on a per subscriber contact basis in an example where total channel costs for a day were $250 and 2 million customers were contacted would be $1.25×10⁻⁴. Costs associated with operating the marketing strategy, or f₄ operational expenses, may be obtained, assessed, observed, and/or detected using a variety of formulas, though certain organizational principles may further augment the system and method for the quantitative measurement and reduction of marketing entropy using geometric methods and heuristics. First, it may be safely said that level one support may have certain fixed costs, which may not be specific to any campaign and/or customer, but should be assigned as a cost to any marketing strategy plan in order to fairly assess its profit potential. Other operational costs, however, may be capable of fair assignment to a particular offering, campaign, and/or customer or customer population. For instance, a new service which requires the activation of new equipment may require more labor costs than a service which does not. Additionally, specific customers or products may require additional technical support or assistance, which can be fairly traced to said product and/or customer. Furthermore, sales representatives may be featured and/or required as a part of a marketing plan, which can be assigned into the f₄ operational expenses category, and each can be estimated/assumed on a per-event basis based on known valuation principles. Turning to Effects E, these can be categorized into whether a customer is aware (E₁) of the service, has realized (E₂) an interest in the service, or has taken some action (E₃) in furtherance of obtaining the service. Then, an event driven scoring algorithm may be deployed to compute the Effects E using product family and impression-engagement bindings. Decay in score day-on-day may be assumed after an impression has been made upon a customer and decay me adjusted along the spectrum of awareness to action. Then, as impressions and/or contacts are made, an effects score may be increased by a certain amount and decayed over a period of time if no further action is taken. Contrarily, if an effect is detected, such as clicking on an ad or obtaining a quote for a specific service, the effects score may be increased. Turning to returns R, these may be understood as actualities or actions of the end user that bring value to the enterprise either in monetary or non-monetary terms. These may be understood categorically to include R₁ revenue, R₂ engagement R₃ satisfaction, and R₄ influence spread. Much like effects E, these categories may be understood along a spectrum. While any customer may be delivering revenue to a business, not all may be engaged, fewer may be satisfied, and only the best customers are evangelists. R₁ revenue as it relates to any particular customer and/or service may be easily obtained at any given point using many known database and/or customer relationship management systems. Given that it may be essential to the disclosed system and method for the quantitative measurement and reduction of marketing entropy using geometric methods and heuristics that they have instant, cheap access to voluminous customers and their engagement R₂ to accurately assess a campaign/strategy, a schema may be developed to determine whether any given user has used any given service on any given day. Such a schema, further described as it relates to FIG. 4, may track, for example, a user's daily use of three separate services may be tracked on 1152-bit pages, consuming only a page in a data layout and enabling quick-read access to whether any given user used a service on any given day. Then, perhaps critical to understanding the construction of a nine-point circle which can be useful for a system and method for the quantitative measurement and reduction of marketing entropy using geometric methods and heuristics may be the determinization of subscriber line-of-sight as it relates to marketing. Line of sight value for any subscriber may be computed by tabulating, decaying, and summing up the residual values obtained from customer driven interactions in the recent past. Then, once appropriate systems are designed to assess the efforts, effects, and returns of a marketing strategy have been established, user activity can be monitored via datastream 299 to obtain certain insights, which may be further obtained using certain variables which may obtained using triangle 330 therein FIG. 3C. Individual subscribers may then be monitored along each domain (i.e., efforts, effects, returns), and the values of an entropy triangle's side lengths can be obtained from formulae comparing changes in these values over time, using a proposed concept of customer line of sight (2).

With respect to determining any particular customer's line of sight with regards to any particular marketing strategy being studied, one can categorize a contact situationally, into for example, sustenance, upselling, cross selling, and winning back. It stands to reason that contacts which are designed to merely sustain the customer engagement would be tabulated differently from those designed to increase a user's engagement with a service, which would further be tabulated differently from those designed to pivot a user to engagement with another service and yet further tabulated differently than those designed to re-engage a customer who is no longer engaged with a service. Furthermore, decaying the value associated with these contacts may further be decayed differently over time during monitoring. Then, when assessing whether making additional contacts of any of these categories, a line of sight may be obtained with up-to-date real time information about the customer's current level of relative engagement with the service and its marketing. Additionally, certain synergies may be observed between cross selling, upselling, and sustaining while avoiding pitfalls from over contacting customers. Furthermore, various mechanisms of decay may be used for each category, e.g., flat, uniform, exponential. Put simply, customer line of sight may be an attempt to quantify the current state of mind of any customer in relation to consideration of a particular service. Then, line of sight value for any subscriber may be computed by summing up residual values obtained from customer driven interactions in the recent past. While certain considerations may be made by those having ordinary skill in the art in developing an arithmetical schema, by imposing adjustments to changes in λ unilaterally across a population being studied, comparison of relative λ among a subscriber population can be made. Having set up a framework to model each contact type and develop a logical decay framework thereof, an entropy triangle may be obtained for each subscriber by the following proposed formulae:

$$FE = ( \frac{{FE}_{Net Swing}}{λ} * {1.1}^{nudges} ) + θ$$

$$ER = \frac{{ER}_{Net Swing}}{{λ}_{Mean Net Swing}}$$

$$FR = \frac{FE}{Mean FE} OR ( {FR}_{Net Swing} ) * {δλ}^{2}$$

Using these formulae to obtain side lengths for a proposed entropy triangle for each subscriber, and maintaining these entropy triangles can offer certain various insights in order to better classify subscribers and target them for contextual marketing. As it relates to the first formula, net swing may be obtained by determining the change in efforts and effects for a given subscriber between a t₁ and t₂. The resulting number can be divided by the customer's current line of sight and multiplied by 1.1 raised by the number of nudges made during the period between t₁ and t₂. Optionally, a constant (or variable) may be added in order to account for certain circumstances which may be familiar to those having ordinary skill in the art. As may be well known, adding a constant in a heuristic tracking formula can serve several key purposes, often enhancing the robustness and usability of the formula in different ways, e.g., offsetting for baseline adjustments, handling of sparse or early data, improving stability, improving predictability, biasing the output, or ensuring positivity in algorithmic functions/calculations. In general, adding a constant, e.g., θ, may allow for flexibility, improving the formula's reliability across different data ranges and enhancing interpretability. Turning to the formula for calculating side ER, net swing of E and R for each subscriber are each obtained and divided by a mean (or decile mean) of λ. So, a subscriber in the 3^{rd} decile's net swing for effects and returns might be divided by an average of that decile's λ swing. Finally, side length of FR may be obtained using the exemplary formula of dividing the FE side length obtained in the first formula by the mean FE for a subscriber population or, perhaps preferably, a subpopulation's average FE. Returning to the proposed exemplary categories of marketing contacts of sustenance (λ_{α}), upselling (λ_{β}), cross selling (λ_{γ}), and winning back (λ_{δ}), overall values for λ may be maintained while considering certain logical formulations for maintaining healthy customer/enterprise interactions automatically. If we are to assume that sustenance contacts serve to maintain existing customer engagement levels, upselling and cross selling to increase engagement, and winning back to restore lost engagement, and that each contact type is being tracked and decayed over time to sustain both overall line of sight values and contact-type line of site values, certain considerations can be made to further model and shape customer engagement. For instance, if customer's “win back” λ_{α} score were positive (meaning they had recently been contacted for returning to a service offering), that it is also higher than maximum scores for upselling and/or cross selling, and if sustenance scores are less than minimum scores for upselling and/or cross selling, a gross mismatch might be observed and provision could be made to limit sustenance contacts further and increase one or more of winning back, upselling, cross selling. In another example, if sustenance contacts represent more than, e.g., 60%, of the current overall λ, and if the ratio of maximum upselling and cross selling values to minimum upselling and cross selling values is greater than, e.g., 3, it may be stated that there may be a synergistic relationship between the business and subscriber and that delicate upsells/cross sells may be worthwhile. In yet another example, if sustenance efforts (λ_{α}) are quite high, e.g., 85%, and winning back efforts (λ_{δ}) fall well below cross selling and/or upselling (e.g., if their maximums are more than double λ_{δ}), a state of lethargy may be assumed. Using these frameworks—gross mismatch, synergy, and lethargy—to categorize events within the FER framework, further prescriptive actions may be taken during active/passive campaigns in order to better model entropy and reduce wasted efforts. For example, in gross mismatch situations, entropy values may be increased by an order, a value, a percentage, or degree, etc. and decreased by the same in synergistic situations. These proposed exemplary event types and the logical conditions thereof can be summarized as follows:

$$If : {λ}_{δ} > 0 AND {λ}_{δ} > max ( {λ}_{β} , {λ}_{γ} ) AND {λ}_{α} < min ( {λ}_{β} , {λ}_{γ} )$$

### Then: Emit Gross Mismatch Event

$$If : {λ}_{α} > 0.6 λ AND \frac{max ( {λ}_{β} , {λ}_{γ} )}{min ( {λ}_{β} , {λ}_{γ} )} > 3$$

### Then: Emit Synergy Event

$$If : {λ}_{α} > 0.85 λ AND {λ}_{δ} < 1 / 2 max ( {λ}_{β} , {λ}_{γ} )$$

### Then: Emit Lethargy Event

Having described means for establishing values related to Efforts F, Effects E, and Returns R in relation to a customer population's line of sight λ in order to obtain side lengths for a proposed triangle having a nine-pointed circle, various formulas may be used upon the values and qualities thereof the corresponding geometric shapes in order to appreciate various insights related to marketing entropy. These values may offer inherent meaning or provide further insights to those monitoring marketing campaigns for efficiency via further calculations/transformations/analysis. The following formulae are provided for calculating μ₁₋₇, letters and symbols corresponding to FIG. 3C:

$${μ}_{1} = \frac{Area of circle out of triangle}{Area of circle}$$

$${μ}_{2} = \frac{Fv}{FR}$$

$${μ}_{3} = \frac{Fr}{FE}$$

$${μ}_{4} = \frac{Ep}{ER}$$

$${μ}_{5} = \frac{Perimeter of circle contained in triangle}{Perimeter of circle}$$

μ₆=The sequence in which the 9 points [a, b, c, p, q, v, x, y, z] appear (e.g., in hexadecimal)
μ₇=The lengths of the 9 arcs (pairwise) from μ₆

Turning now to FIG. 4, illustrated therein may be an exemplary data layout for continuous logging of customer engagement data to obtain instant access using direct date addresses. Data layout 400 may be stored on non-transitory computer readable medium or held in memory/RAM. Then, each 1152-bit page can be assigned a subscriber, e.g., Alice, Bob, and Clarke. Each subscriber's daily usage of 3 particular services (e.g., voice, data, app) can be monitored and indicated according to a direct address on the page where DA={Service×384}+ {Month×32}+Day in bit decoding. Then, to know if any particular subscriber was engaged with any particular service on any particular data can be readily obtained and determining which of millions of subscribers or which of a subset thereof can be obtained more readily, where otherwise determining such quickly may have been impossible.

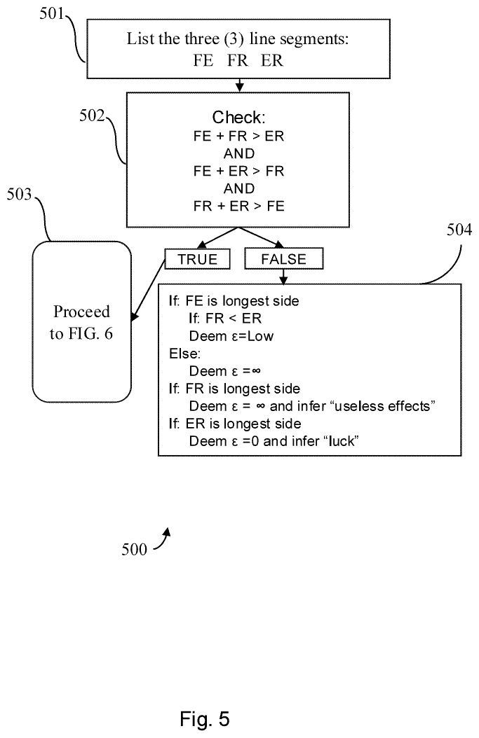

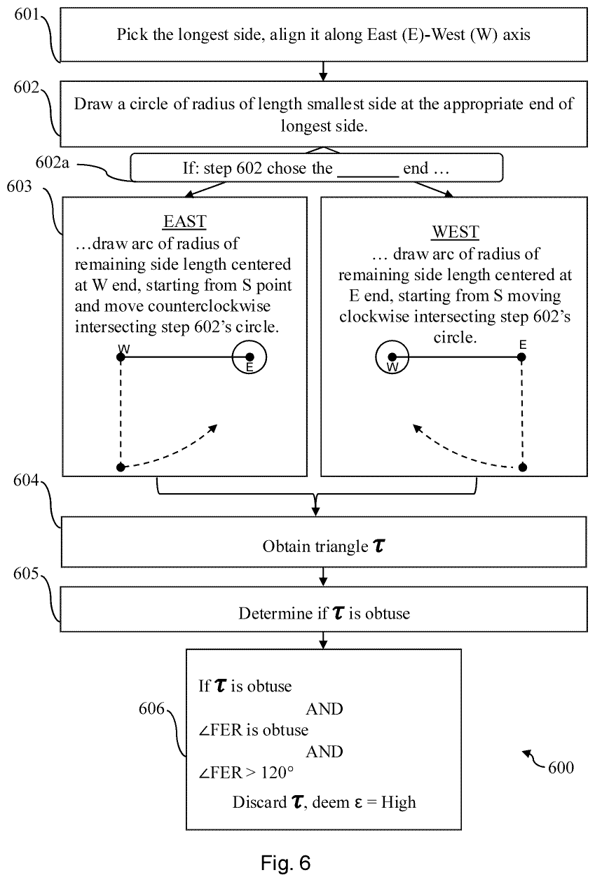

Turning now to FIG. 5, illustrated therein a flowchart diagram of initial organizational steps of the methods of the disclosure, namely the construction of a nine-point triangle under the principles of the disclosure as described in relation to FIGS. 3A-C. Beginning at step 501, the three line segments of triangle 330 for a proposed or active marketing strategy are listed as: FE, FR, and ER and a check is performed at step 502. The check performed at step 502 determines whether each of the following are true: FE+FR>ER; FE+ER>FR; and FR+ER>FE. This step ensures a legal triangle is possible. If true, the steps of FIG. 6 are instructed. If false and a legal triangle cannot be formed, the following checks are made at step 504. If FE is the longest side and if FR<ER, entropy can be considered low and be deemed a low integer, but if ER<FR, entropy can be deemed to a set integer, e.g., 20. If FR instead is the longest side, entropy can be again deemed to a set integer and an inference can be made that there are useless effects. Finally, if ER is the longest side, entropy can be deemed to zero and positive results can be inferred as lucky. Over time, further checks upon each subscriber failing to form a legal triangle may be performed and upon successful assembly, the steps of method 600 of FIG. 6 occur.

Turning now to FIG. 6, illustrated therein is a flowchart diagram of additional organizational steps of the disclosure, starting from step 503 of FIG. 5. Previous to step 503 of FIG. 5, a check was performed to ensure a legal triangle could be formed of the sides FE, FR, and ER. At step 601, the longest of those sides is chosen and aligned along an East-West axis. At step 602, a circle having a radius of the shortest side of the triangle is constructed from the appropriate end of the line chosen at step 601. If the East end was chosen at 602, an arc is constructed of radius length of the remaining triangle side centered at the West end, starting from the South side and moving clockwise until intersecting step 602's circle. If the West end was chosen at step 602, an arc is constructed of radius length of the remaining triangle, centered at the East end, starting from the South side and moving clockwise until intersecting step 602's circle. Having identified each point of triangle 330, a triangle τ can be constructed and/or identified at step 604. Having obtained triangle τ, a check of triangle type can be performed to determine whether the triangle is obtuse at step 605. Then, a series of steps can be performed to determine whether entropy is high, namely whether it is ∠FER that is obtuse, and if so, whether its angle exceeds 120°, and if so, it can be discarded at step 606.

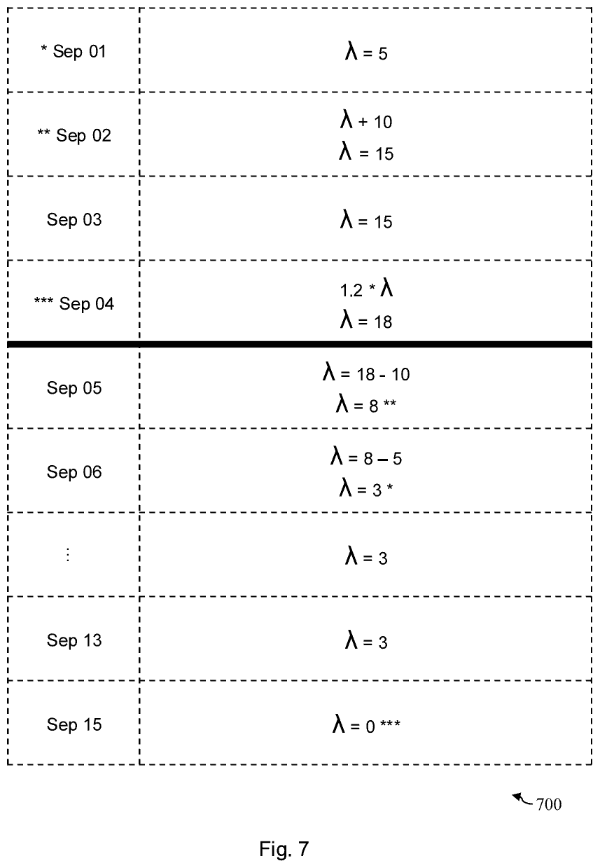

Turning to FIG. 7, illustrated therein is a block diagram of an exemplary heuristic framework for determining line of customer sight to a marketing campaign at any given point in time. Considering a customer who has been identified as a subject of a marketing campaign and their line of sight (λ) along calendar 700, which features a portion of September of a year. By considering marketing contacts, such as targeted contacts, push-pull contacts, and retargeting contacts, separately as having different effects which last (or decay) differently, overall λ can be monitored along a calendar to obtain up to date λ values over various periods of marketing contacts over a campaign. So, where asterisks indicate a contact type according to the key—*targeted contact, **push-pull contact, and ***retargeting—this customer was initially targeted on September 1, push-pulled on September 2, and retargeted for an earlier targeted objective on September 4. Having no other indications, this customer was not contacted again for this campaign or any other. In order to best model λ, an initial target may be assigned a uniform addition to λ of, e.g., 5, which may decay on a flat basis at 5 days if no contact is made. Then, due to the push-pull contact, λ may raise by, e.g., 10, which may decay on a flat basis over 3 days. Then, due to the retargeting, which may have a percentage/multiplier rather than additive effect, the customer line of sight λ may raise, e.g., by 20%, which may decay on a flat basis. Then, it can be observed that this customer's line of sight λ at the beginning of September when initially contacted was 5. Being subject of the push-pull campaign on the 2^{nd} may then raise λ to 15, via simple addition. Contacted again on the 4^{th}, this time with a retargeting campaign, raises λ to 18, which is 120% of 15. On the 5^{th}, since 3 days have passed since the push-pull campaign, 10 is subtracted from λ to decay the push-pull's effect on λ. On the 6^{th}, since 5 days have passed from the initial targeting, 5 is subtracted from λ, leaving 3 remaining. On the 13^{th} it may remain at that level until the 14^{th}, or 10 days after the retargeting, when it may drop to zero, as indicated therein. Further indication of λ during a customer journey, its impact on triangle 330's transformation, and overall importance within the system and method for the quantitative measurement and reduction of marketing entropy using geometric methods and heuristics of the disclosure may be more apparent from further review of the Drawings in relation to the remaining Detailed Description.

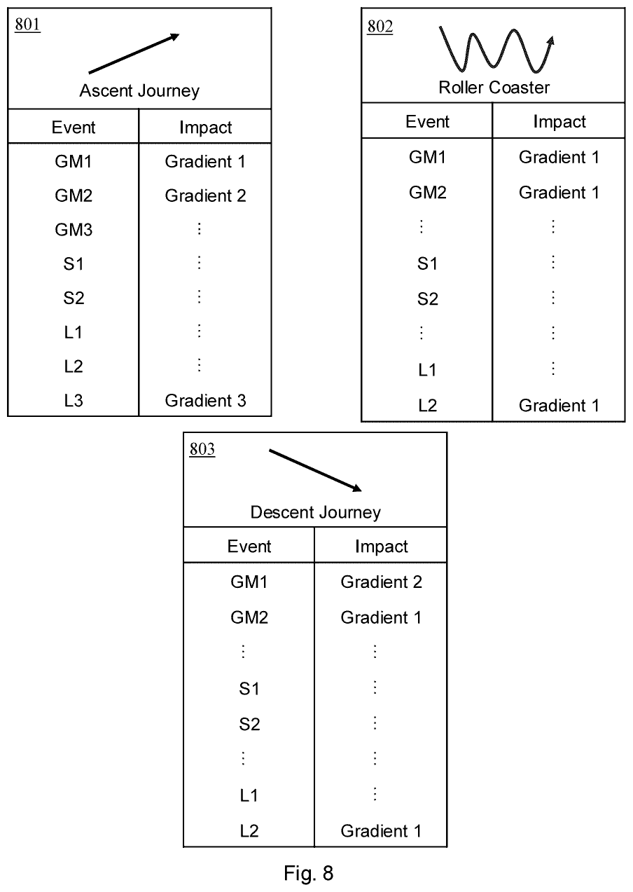

Turning now to FIG. 8, illustrated therein are block diagrams representing various exemplary customer journey types and various proposed impact matrices which may be related thereto. As it relates to those columns on the left marked “Event”, may indicate events described as gross mismatches, synergistic, and lethargic above. These may occur in specific scenarios where customer contacts in recent history indicates a prescription can be made to decrease entropy. It may be noted at the outset that these customer journeys are exemplary only and not exhaustive. Those having ordinary skill in the art may understand other heuristic frameworks for modelling customer line of sight, which may feature distinct proposed impact matrices from that of the disclosure herein. Starting with an ascent journey 801, an impact matrix may initially capture the overlay gradients to use on relay of certain events listed thereon the lefthand column, where events are catalogued to determine an appropriate overlay impact matrix to model decay of the contact's effect over time. Then, under an ascent journey 801 framework, the gradients listed on the righthand column may be used to model the impact of events, adjusting 2 accordingly over time. As used in the examples therein FIG. 8, a rubric may be developed to determine certain types of gross mismatch, lethargic, and/or synergistic scenarios and a plan may be formed for handling each various event. For example, if a customer has not acted upon a specific number of “win back” communications, an event may be triggered and classified as GM1. If communications represent mostly sustenance with a close line of sight, an event may be triggered and classified as S1. Then, the impact overlays can be selected by, for example, sampling a subset of previous lines of sight to determine a positive or negative entropy trend, and applying the corresponding impact overlay. These impact overlays may in turn be further differentiated by whether they are ascending, descending, and doing so on a flat, uniform, concave, steep, etc., depending on business logic. Then, upon determination as to whether a customer is on a certain journey type, e.g., ascent 801, roller coaster 802, or descent 803, the appropriate line of sight impact matrix overlay can be selected in order to best model customer behavior during the journey. Since ascent, from an entropy perspective, has a negative connotation and descent has a positive connotation, steeper curves in either direction indicate greater impacts. By further transforming variables related to triangle 330 through active and passive communications, and by cataloguing the resulting events such that adjustments may be made to limit overall entropy in future communications, overall communication can be further improved.

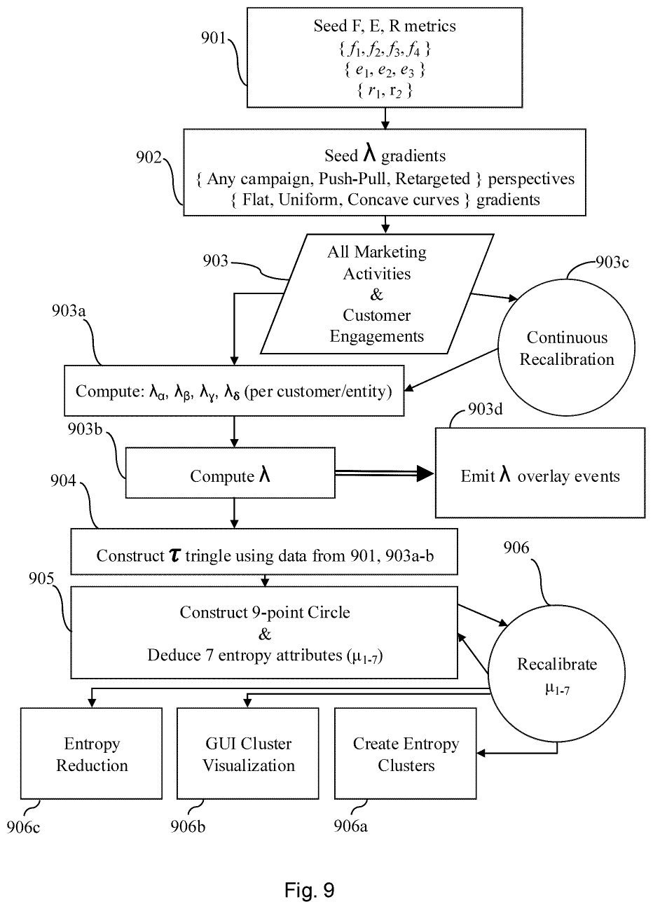

Turning now to FIG. 9, illustrated therein is a method flowchart of an exemplary entropy recalibration and reduction process, combining the concepts of the disclosure into the system and method for the quantitative measurement and reduction of marketing entropy using geometric methods and heuristics. Beginning at step 901 of method 900, F, E, and R metrics are seeded, including {f1, f2, f3, f4}, {e1, e2, e3}, and {r1, r2} domain metrics, according to the principles described above. Then, at step 902, λ gradients are seeded and perspectives and gradients are assigned according to those principles described in relation to FIGS. 7-8. Once F/E/R metrics and λ gradients have been seeded, outgoing (e.g., marketing contacts) and incoming (e.g., customer engagements) activities are monitored via datastream 299 at step 903. At step 903a, λ_{α}, λ_{β}, λ_{γ}, and λ_{δ} are each computed continuously during a monitoring period. As this is calculated, additional activity information may arrive via datastream 299, which is continuously recalibrated at step 903c. As λ_{α}, λ_{β}, λ_{γ}, and λ_{δ} are each computed continuously for each customer, λ can be computed at step 903b and emitted at certain overlay events at step 903d. Then, using the F/E/R metrics obtained at step 901 along with transformations that have occurred at steps 903a-b, triangle τ may be constructed at step 904, which in turn can provide the nine-point circle construction, which can enable the mathematical calculation of entropy attributes μ₁₋₇, according to the principles described in relation to FIGS. 3A-C therein step 905 of method 900. Having obtained μ₁₋₇ for a subscriber population and/or subpopulation, steps can be taken to influence (i.e., reduce) overall entropy related to customers and recalculated and/or recalibrated at step 906 in order to generate entropy clusters 906a, visualize clusters via GUI 906b, and/or continue reducing entropy 906c according to the principles of the disclosure. With respect to generating entropy clusters 906a, this may be achieved through various techniques. First, subscribers may simply be grouped with those having entropy values within a given percentage, e.g., 10% decile clusters. They may also be clustered according to certain angular measurements, e.g., ∠ERF and ∠RFE within 5° of each other. Other clustering 906b examples may include grouping all subscribers with cardinality of distinct points as it may relate to u, or other relationships thereof. As understood by those having ordinary skill in the art, clustering may be important to identify subpopulations for study, analysis, testing, and/or experimentation at entropy reduction (or other business related goals) and may further reveal hidden traits which subscriber populations may share that may not otherwise be readily observable. Other steps, such as continuing to reduce entropy 906c may be achieved through various other transformations. For instance, subscribers could first be ranked by entropy scores on a descending basis for a particular campaign and marketing efforts can be limited to those having lower entropy scores.

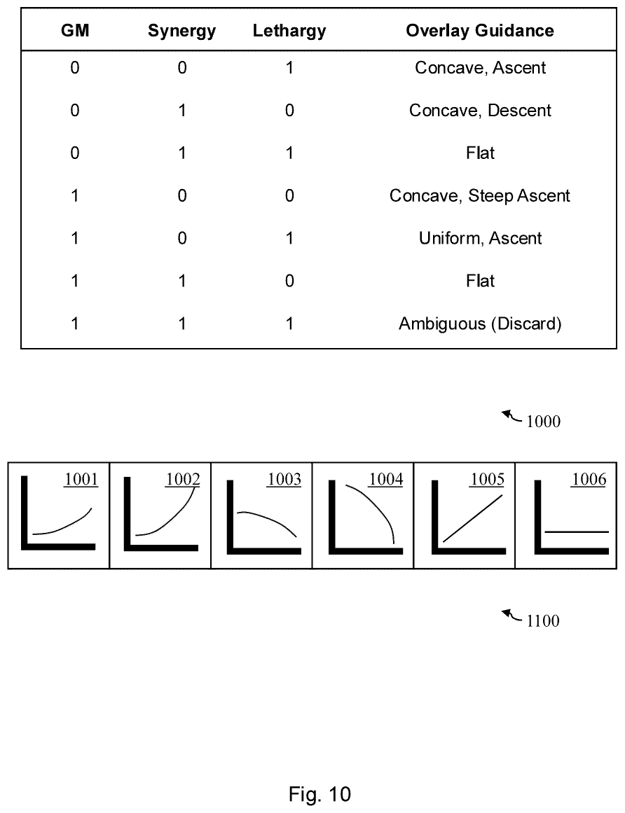

Turning now to FIG. 10, illustrated therein is a Boolean table showing exemplary overlay schema related to customer journeys, event types and corresponding exemplary overlay curves. Beginning with Boolean table 1000, illustrated therein are 3 Boolean columns indicating gross mismatch (GM), synergy(S), and lethargy (L) event types. Such event type descriptions and impact overlays are thoroughly described above in relation to FIG. 8 and the overlays illustrated and described therein. Boolean table 1000 can therefore be prescriptive as to which journey type to indicate and what impact overlay to select. As overlay gradients are continually used on relaying of information related to events, selection may be made via overlays in order to properly model how the overlays themselves have contributed (either positively or negatively) to entropy in the past. As such, journeys can be based on overlay feedback, which may in turn affect and/or dictate the next impact. Entropy ascent implies increasing entropy and entropy descent implies decreasing entropy, such that impact matrix overlays can be logged and studied after a successive series of events. If, for example, six events are selected, they can be constructed into seven pairs. Then, if 4 or more pair sets have a positive slope, entropy is increasing and the journey can be said to be ascending. If, however, 4 or more pairs have a negative slope, entropy is decreasing and the journey can be said to be descending. If neither is true (i.e., if half are positive and half a negative slopes), the journey can be said to be a roller coaster. Then, an appropriate overlay curve can be selected in order to better model entropy. Additionally and/or alternatively, Boolean table 1000 may function prescriptively such that record of successive impact matrix events are kept and checked periodically or after a set number of events. Then, if, for example, only lethargy events were recorded, a concave ascent curve may be chosen. If, instead for example, only synergy events had taken place, a concave descent curve might be chosen, as indicated thereon Boolean table 1000. Then, with regard to curve table 1100 and curves 1001-6, which may include concave ascending 1001, steep concave ascending 1002, concave descending 1003, deep concave descending 1004, uniform ascent 1005, and flat 1006, those having ordinary skill in the art may understand the overlay curves illustrated therein to be exemplary only and sufficient experimentation may yield ideal mathematical functions.

With respect to the above description then, it is to be realized that the optimum methods, systems and their relationships, to include variations in systems, machines, size, materials, shape, form, position, function and manner of operation, assembly, order of operation, type of computing devices (mobile, server, desktop, etc.), type of network (LAN, WAN, internet, etc.), size and type of database and/or services provisioned, data-type stored therein databases, and uses thereof, are intended to be encompassed by the present disclosure.

In select embodiments, additional digital engagements, interactions, customer journeys, customer engagement, and other events between brands and customers may be monitored in various forms, including but not limited to social media following/posts, email and SMS marketing (responses), online reviews across a plurality of online review platforms, chat/support interactions, purchases, subscriptions, referrals, “@” mentions, the download/installation/use of mobile apps and other software, the like and/or combinations thereof. Variation may exist among the described engagements and the weights/algorithms/maps assigned thereto. The subject matter of the disclosure is not limited to one particular industry, business type, website, social media platform, or entertainment platform, and the systems and methods disclosed herein are not limited in utility to social media, streaming platforms, review sites, app stores, support platforms and telecommunications device/service. Relevant sectors for use of the system and method of the disclosure may also include agriculture, forestry, fishing, banking, finance, residential/business telecommunications, mining, manufacturing, construction, hospitality education, arts, retail, utilities (e.g., electric, water, gas), healthcare, entertainment, broadcast media, other forms of social media not recited herein, the like and/or combinations thereof.

The foregoing description and drawings comprise illustrative embodiments of the present disclosure. Having thus described exemplary embodiments, it should be noted by those ordinarily skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments of the disclosure will come to mind to one ordinarily skilled in the art to which this disclosure pertains having the benefit of the teachings presented in the foregoing descriptions and the associated drawings. Although specific terms may be employed herein, they are used in a generic and descriptive sense only and not for purposes of limitation. Moreover, the present disclosure has been described in detail, it should be understood that various changes, substitutions and alterations can be made thereto without departing from the spirit and scope of the disclosure as defined by the appended claims. Accordingly, the present disclosure is not limited to the specific embodiments illustrated herein, but is limited only by the following claims.

1. A computer-implemented method for quantifying marketing entropy associated with each subscriber in a telecommunications network having a plurality of subscribers, the method comprising:
tracking, by a processor, marketing activities directed toward each subscriber and assigning an Effort (F) parameter for each event in a sequence of events over time;
tracking, by the processor, an at least one revenue amount associated with each subscriber and assigning a Relative Returns (R) parameter associated with revenue in said sequence of events over time;
tracking, by the processor, a plurality of subscriber activity associated with any event in said sequence of events over time;
generating, by the processor, a geometric representation marketing effectiveness in the form of a triangle, where each vertex of the triangle corresponds to a parameter among Effort (F), Effect (E), and Return (R), and the changes in values of F, E, and R define the vertices of the triangle having sides FE, RE, and FR;
generating, by the processor, a nine-pointed circle of the triangle;
calculating a series of variables for each subscriber, wherein the series is based on values and qualities of said nine-pointed circle and said triangle; and
assigning, by the processor, an entropy value to each subscriber based on the series of variables.

2. The method of claim 1, further comprising a step of ranking said plurality of subscribers based on said entropy score.

3. The method of claim 2, wherein the ranking step is performed in descending order.

4. The method of claim 3, further comprising segmenting said plurality of subscribers into entropy deciles.

5. The method of claim 1, wherein said Effort (F) parameter includes a strategy cost sub parameter, a computing cost sub parameter, a relay cost sub parameter, and an operational expenses sub parameter.

6. The method of claim 5, wherein said Relative Returns (R) parameter includes a revenue sub parameter, an engagement sub parameter, a satisfaction sub parameter, and an influence spread sub parameter.

7. The method of claim 6, wherein said Effects (E) parameter includes an awareness sub parameter, a realization sub parameter, and an action sub parameter.

8. The method of claim 1, further comprising identifying a customer journey overlay for each subscriber of said plurality of subscribers.

9. The method of claim 8, wherein said customer journey overlay is selected from a group of overlays, the group comprising ascent, descent, and roller coaster.

10. The method of claim 9, wherein said customer journey overlay is selected for each subscriber after a number of events.

11. A system for quantifying marketing entropy associated with each subscriber in a telecommunications network comprising a plurality of subscribers, the system comprising:
a processor configured to:
track marketing activities directed toward each subscriber over a sequence of events in time and assign an Effort (F) parameter for each event;
track an at least one revenue amount associated with each subscriber and assign a Relative Returns (R) parameter associated with said revenue over said sequence of events;
track a plurality of subscriber activities associated with any event in said sequence of events;
generate a geometric representation of marketing effectiveness in the form of a triangle, where each vertex of the triangle corresponds to a parameter among Effort (F), Effect (E), and Return (R), with changes in values of F, E, and R defining the vertices of the triangle having sides FE, RE, and FR;
generate a nine-pointed circle based on said triangle;
calculate a series of variables for each subscriber based on the values and qualities of said nine-pointed circle and said triangle; and
assign an entropy value to each subscriber based on the series of variables, wherein the entropy value indicates the level of marketing impact on the subscriber's engagement behavior.

12. The system of claim 11, wherein the processor is further configured to perform a step of ranking said plurality of subscribers based on said entropy score.

13. The system of claim 12, wherein the ranking step is performed in descending order.

14. The system of claim 13, wherein the processor is further configured to perform a step of segmenting said plurality of subscribers into entropy deciles.

15. The system of claim 11, wherein said Effort (F) parameter includes a strategy cost sub parameter, a computing cost sub parameter, a relay cost sub parameter, and an operational expenses sub parameter.

16. The system of claim 15, wherein said Relative Returns (R) parameter includes a revenue sub parameter, an engagement sub parameter, a satisfaction sub parameter, and an influence spread sub parameter.

17. The system of claim 16, wherein said Effects (E) parameter includes an awareness sub parameter, a realization sub parameter, and an action sub parameter.

18. The system of claim 11, wherein the processor is further configured to perform a step of identifying a customer journey overlay for each subscriber of said plurality of subscribers.

19. The system of claim 18, wherein said customer journey overlay is selected from a group of overlays, the group comprising ascent, descent, and roller coaster.

20. The system of claim 19, wherein the processor is further configured to select said customer journey overlay for each subscriber after a number of events.
